(19) United States
(12) Patent Application Publication
(10) Pub. No.: US 2003/0151632 A1
(43) Pub. Date: Aug. 14, 2003

(54) User interface system for applying decision values to objects

(76) Inventors: Seh M. Ryu, Houston, TX (US); Kong M. Chan, Houston, TX (US)

Correspondence Address: NICK A NICHOLS, P O BOX 16399, SUGARLAND, TX, 774966399

(21) Appl. No.: 10/073,431

(22) Filed: Feb. 11, 2002

(51) Int. Cl. G09G 5/00

(52) U.S. Cl. 345/853

(57) ABSTRACT

A user interface system is disclosed which is useful for applying decision values to objects defined in terms of attributes, incorporating the concepts of inheritance, adoption, and rebel values. This invention addresses a group of objects that retain the same set of attributes and applies decision values to the selected groups of objects using a value inheritance system analogous to that of an ancestral tree. This invention employs novel methods for constructing a virtual single hierarchical system out of any multiple attributes system, inheriting decision values along family tree lines, and displaying the user's assignment decisions.

### BACKGROUND OF THE DISCLOSURE

The present invention relates generally to data processing particularly to a user interface for applying decision values to groups of objects within a database.

Despite significant advances in computer technology and the expanding use of the internet to conduct business, when simulating business operations, such as business processes, rules, procedures, contracts and workflow, decision-makers who are not trained in computer programming languages can make only limited choices from among those preprogrammed. For those not in the programming profession, defining a group of objects to address, among hundreds or thousands of those stored in a database, applying decisions values to that group of objects, viewing the results and making further revisions, is an arduous task.

### SUMMARY OF THE INVENTION

The present invention is a user interface that provides a method for setting up business rules and procedures, and communicating them to those who will manually or electronically perform a business operation. A business operation generally consists of conducting “work” based upon a pre-determined set of rules and procedures, and can be expressed in terms of objects and the decision values applied to those objects. The present invention provides a means for users to first, broadly select groups of objects from within a database, and apply decision values for all groups once, and then, select more narrowly defined subgroups or individual objects, and create exceptions to the previous set by applying different decision values to those groups or objects. The user can continue creating exceptions in this fashion until all of the desired decision values are applied. The present invention then provides a concise overview of the decision values applied and provides a means for making revisions.

Within the present invention, objects are organized into a single attribute hierarchy, visually represented in a tree format. The tree format supports only a single attribute hierarchy, however, if the user wants to select objects based upon multiple attributes, it is possible to do so by creating a virtual single-attribute hierarchy. The task of preparing a virtual single-attribute hierarchy requires knowledge of the database. Therefore, in a preferred embodiment of the present invention two different types of users are contemplated, i.e., designers, with knowledge of the database, and decision-makers who are the users. The designer of the present invention first selects a main attribute for the hierarchy, and then inserts the secondary attribute within each of the main attribute's hierarchical members, to form a system which functions as a virtual single-attribute hierarchy. When inserting the secondary attribute, the designer adopts only the members from the secondary attribute that belong to the adopted parent. Therefore, the user interacts with the interface as if dealing with a single attribute system created through this adoption method.

To illustrate further how the present invention works, the hierarchy of an attribute may be described by using the analogy of a family tree. A family tree starts with one original or dominant ancestor, then shows his children, his children's children, and so on. The most broadly defined attribute group in the hierarchy is the dominant ancestor, and the more narrowly defined attribute groups are the children and grandchildren. A child's attribute group contains fewer objects than its parent in general, and the number of objects may be the same only when the parent has only one child. With the tree format, the user can choose to view or hide all of the children within each family attribute group. Secondary attributes are added to each family group as if through adoption. The hierarchy thus constructed is a virtual single attribute family tree.

In accordance with the present invention, a value inheritance system is used to apply decision values on the objects selected using this virtual single-attribute hierarchy. Before the user begins, the designer assigns a decision value to the dominant ancestor, and all of the descendants of the dominant ancestor inherit the designer assigned value automatically. When a user selects more narrowly defined groups and applies different decision values, these become “rebel” children, and the decision value thus assigned is propagated to all of the children, grandchildren and great-grandchildren in the rebel child's line of inheritance. A rebel is, therefore, a child who has received a decision value directly from the user, and not through the value inheritance system. A decision value assigned to a parent is automatically inherited by all of parent's descendants, except for any rebel children and their descendants. Uncles and aunts are not in a child's direct line of inheritance; therefore their assigned decision values do not affect the child. The assigned inheritance values propagate from children to grand children in the direct inheritance line and end when the there are no more descendants in the line, or when a rebel value is encountered.

The value inheritance system allows for the automatic inheritance of decision values that are broadly defined, and also provides for the possibility that the user will want to create exceptions, i.e., more narrowly defined groups within each category, with a decision value that differs from the parent. The user can easily search out these specific objects and change their decision values. The present invention therefore, makes it possible to manage a large amount of data, by allowing the user to select groups of objects, using multiple attributes, apply decision values very broadly, and then narrowly define very specific objects within those groups to apply exceptions.

The assigned decision values described above may be reviewed by the user in a summary format. The summary view displays only the original dominant ancestor, the rebels, and the pathways leading to the rebels, with all rebel values in red text. To revise the decision values assigned, the user may either select a category or group of objects as before and change the decision value shown, or click on a delete button (X) to remove a rebel value. In the first case, when the user changes a group's decision value the new decision value will automatically be inherited by all members, i.e. descendants of the family group, except for any rebels within the group. Rebel children will always maintain their user-assigned values, and can only be removed with the delete button. When a rebel value is deleted, that group or object will return to the inherited value of the nearest parent or rebel ancestor in the direct line of inheritance.

### BRIEF DESCRIPTION OF THE DRAWINGS

So that the manner in which the above recited features, advantages and objects of the present invention are attained can be understood in detail, a more particular description of the invention briefly summarized above, may be had by reference to the embodiments thereof which are illustrated in the appended drawings.

It is noted, however, that the appended drawings illustrate only typical embodiments of this invention and are therefore not to be considered limiting of its scope, for the invention may admit to other equally effective embodiments.

FIG. 1 is a single machine configuration block diagram in accordance with a preferred embodiment of the present invention;

FIG. 1a is a block diagram of a hosted machine configuration in accordance with a preferred embodiment of the present invention;

FIG. 2 is a block diagram illustrating a price model application in accordance with a preferred embodiment of the present invention;

FIG. 3 is a block diagram illustrating an expanded view of a price model application in accordance with a preferred embodiment of the present invention;

FIG. 4 is a block diagram illustrating input of a rebel value in a price model application in accordance with a preferred embodiment of the present invention;

FIG. 5 is a block diagram illustrating a price model application depicting a rebel markup value in accordance with a preferred embodiment of the present invention;

FIG. 6 is a block diagram illustrating an expanded view of a price model application depicting the inherited rebel markup value in accordance with a preferred embodiment of the present invention;

FIG. 7 is a block diagram illustrating an expanded view of a price model application depicting a rebel inheritance value within a rebel category in accordance with a preferred embodiment of the present invention;

FIGS. 8-10 are block diagrams illustrating the adoption of a manufacturer attribute to the product category hierarchy of the present invention; and

FIG. 11 is a block diagram illustrating a summary view of a price model application depicting dominant and rebel values in accordance with a preferred embodiment of the present invention.

### DETAILED DESCRIPTION OF A PREFERRED EMBODIMENT

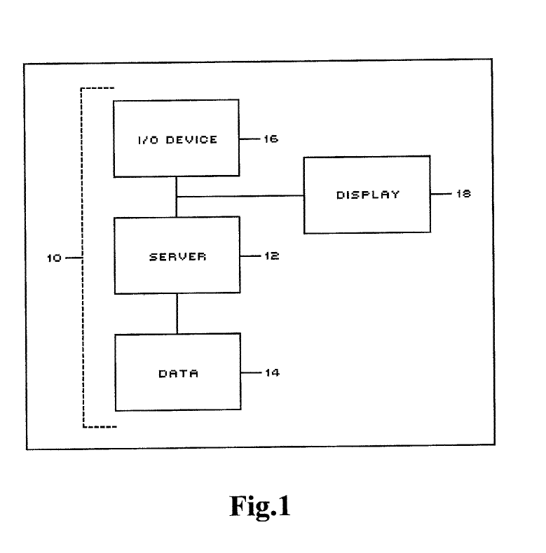

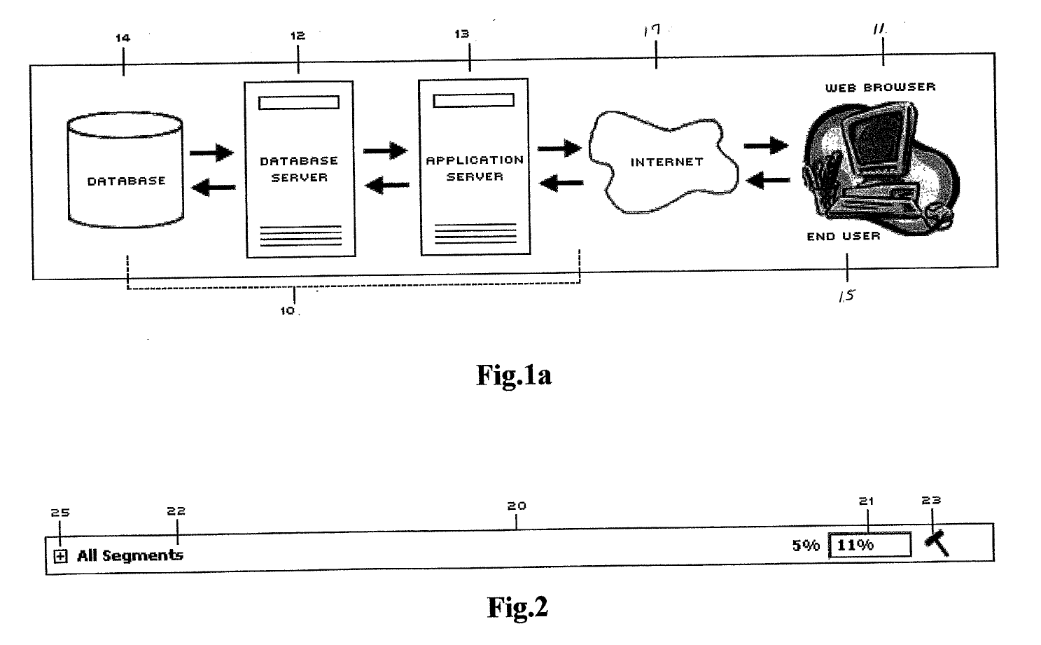

The present invention provides a user interface for simulating business operations. Referring first to FIG. 1, a system for implementing the present invention is generally identified by the reference numeral 10. The system 10 can be implemented on a computer system having typical computer components such as a processor, memory, storage devices, keyboard, display, etc. In the embodiment of FIG. 1, the system 10 includes a server device 12, which is in communication with and having access to data stored in a fixed storage device 14. The server 12 receives input data from an input device 16 and provides information to a user via a display 18.

The system 10 may also be used though a user browser 11 as illustrated in FIG. 1a. The system 10 may be deployed in an application server device 13, which interacts with an end user 15 though user browser 11 via the internet 17. The application server device 13 also communicates with the database server device 12 to read and write data onto database 14. The user browser 11, application server 13, and database server 12 include typical computer components such as processor, memory, storage, and input and output devices.

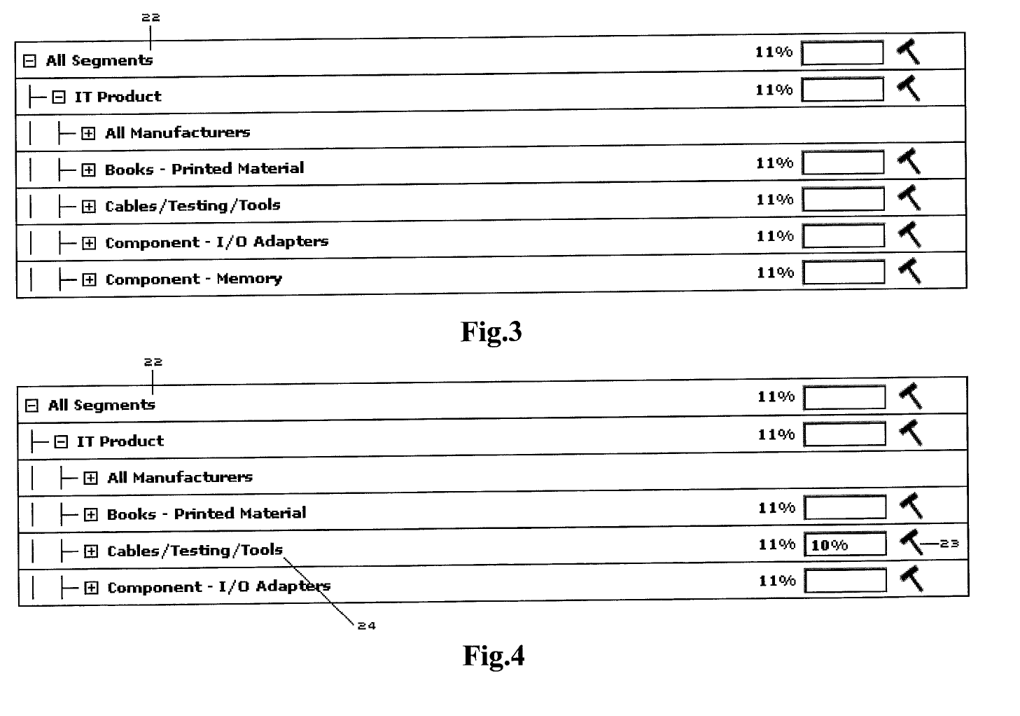

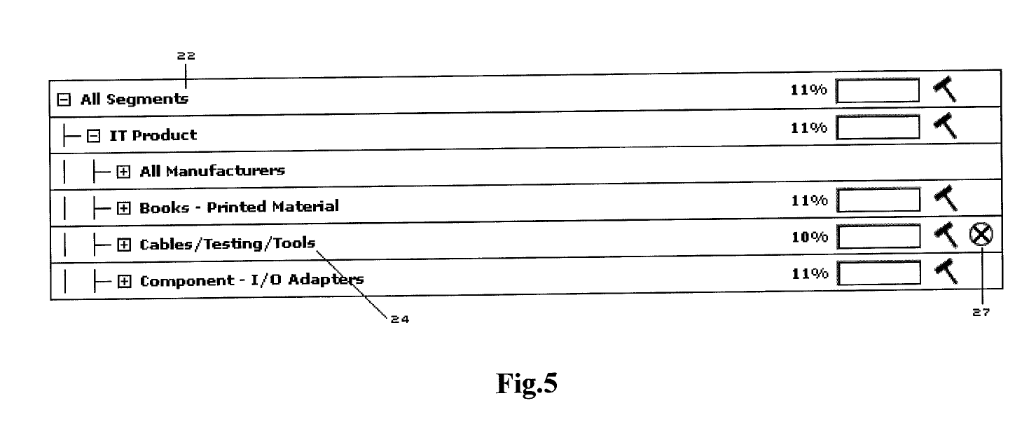

Referring next to FIG. 2, an example of how the present invention works in a price model application 20 is shown. To set up a price model tree with the system software of the present invention, the first step is to broadly assign the decision value of a markup percentage to all products in the database by assigning a markup percentage to the highest parent on the hierarchal tree, i.e. the “dominant ancestor”. In FIG. 2 the dominant ancestor 22 is “All Segments”, which represents all products in the database, has been assigned the decision value of 11% by entering the value in the input box 21 then pressing on the assign icon that has the image of hammer 23. Once the dominant ancestor 22 is assigned a decision value, all products represented by “All Segments” inherit the same markup percentage, i.e., 11% in the example of FIG. 2. It is therefore not necessary to enter the decision values for each of the thousands of products in this database one by one. The user can expand the tree using the plus sign 25 to reveal members nested directly underneath the dominant ancestor 22. The result of the expansion is shown in FIG. 3.

The system of value inheritance implemented by the system 10 of the invention persists on down the tree from parent to child within the database. In FIG. 3, it will be observed that the inherited decision values for children of the dominant ancestor 22 “All Segments” are shown and are equal to the value of the dominant ancestor 22.

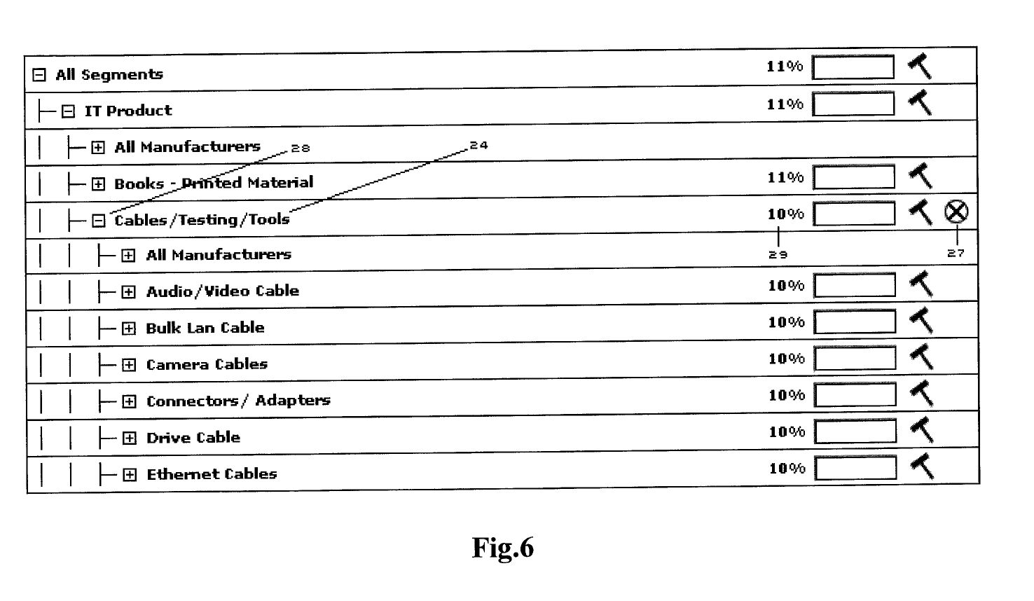

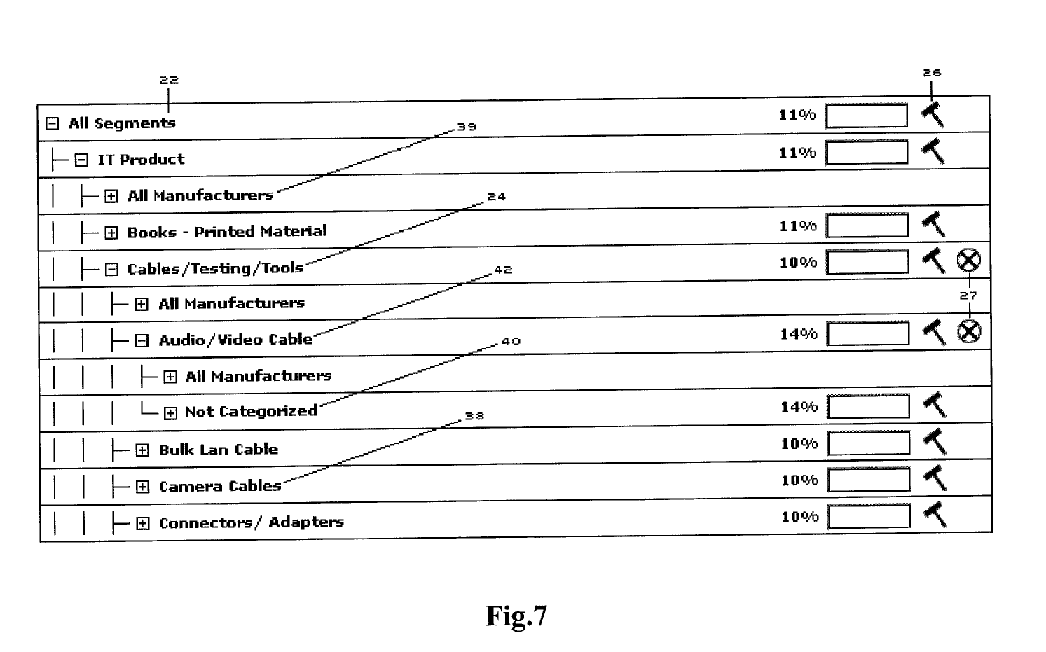

In the price model example described above, a different value, designated as “rebel value” may be assigned to any of the descendants of the dominant ancestor 22. A rebel is a child (category or product) which does not inherit the parent's decision value, but maintains the value assigned directly by the user. In FIG. 4, the tree member 24 identified as Cables/Testing/Tools has been given a rebel markup percentage of 10%, which is different from the value of the dominant ancestor 22. The rebel value is saved by clicking on the save button or icon 23. In FIG. 5 the tree view resulting from the save action is shown. The member 24 in FIG. 5 now has the assigned value of 10% and a cancel button or icon 27 has appeared adjacent the save icon 23 for the tree member 24. The cancel icon 27 visually indicates that the tree member 24 is a rebel.

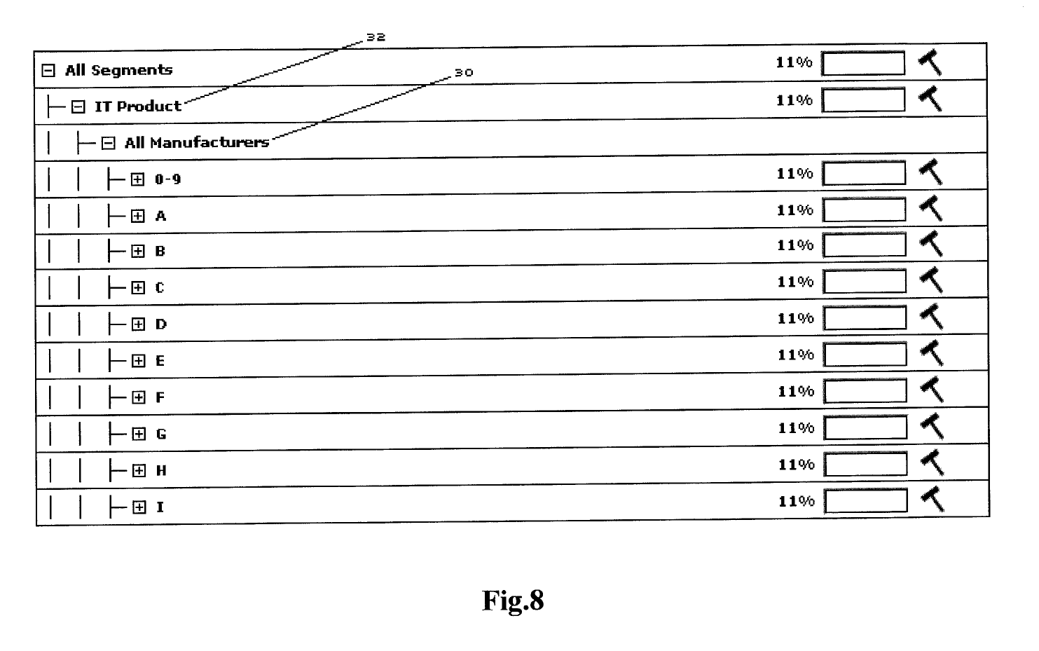

In the expanded view of FIG. 6, it will be observed that the “children” nested underneath the tree member 24, i.e., subcategories of the tree member 24, have inherited the 10% markup percentage from their rebel parent member. The minus sign 28 to the left of the member 24 shown in FIG. 6 indicates that all immediate children of the member parent are displayed. However, none of the children of member 24 display the cancel icon 27, indicating that they are not rebels. They all inherited their parent's value of 10%.

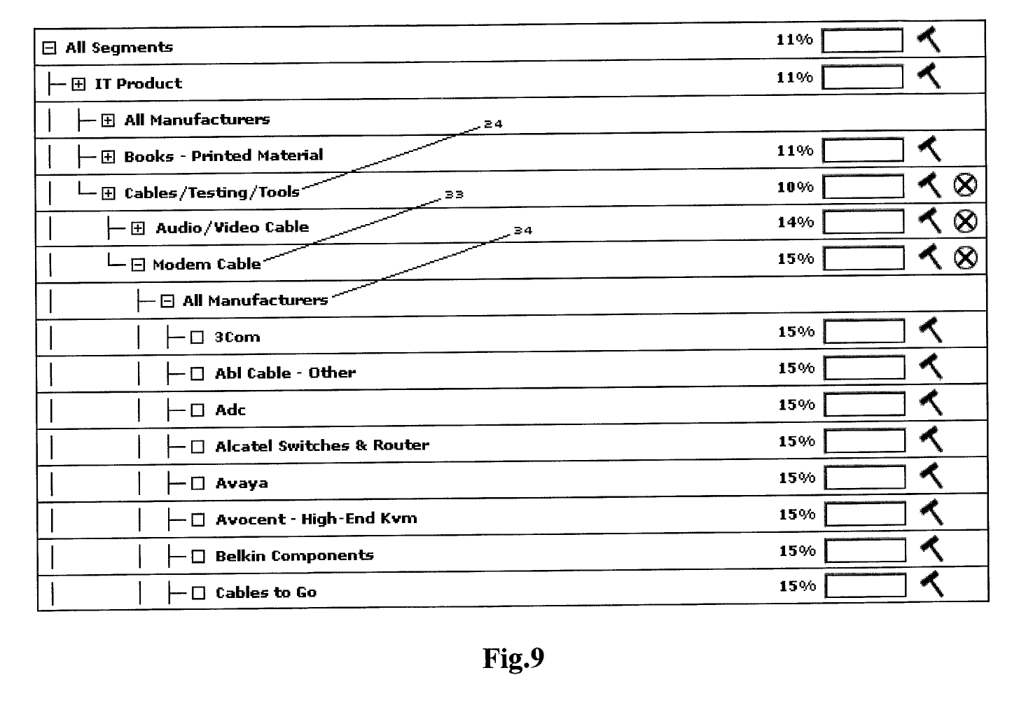

In a complex application, the user can set many members of the families as rebels (FIG. 7). In FIG. 7 two cancel icons 27 are displayed, specifically for members 24 and 42. Member 42, audio/video cables, is a rebel child member of 24 having a different decision value of 14%. If there are no rebels on a tree between a child and it's dominant ancestor, then it will inherit the decision value of the dominant ancestor 22. For example, from FIG. 7 it will be observed that all products defined as Books-Printed Material 39 inherit the 11% markup percentage of the dominant ancestor 22. If there are many rebels along the tree, then the user can determine a child's decision value by looking to the nearest ancestor with a rebel value. Likewise, all descendants of that ancestor who are not themselves rebels, inherit the decision value of its immediate ancestor. For example, referring specifically to FIG. 7, it will be observed that members who are descendants of Cables/Testing/ Tools 24 such as Camera Cables 38 inherit the 10% markup percentage of the ancestor 24. On the other hand even though Audio/Video Cable 42 is a descendant of Cables/Testing/Tools, it retains a rebel value of 14% because it is a rebel who has received its decision value directly from the user. Its descendant, the tree member 40 designated “Not Categorized” inherits the 14% markup value from the Audio/Video Cable rebel parent 42. It is understood, however, that an item or member cannot inherit from a sibling. Siblings may be rebels, but inheritance is always determined by the parent/ancestor relationship.

This invention provides a means of modifying decisions that a user has made. A rebel setting can be undone simply by clicking on the “cancel” button 27 to the right of the markup percentage (FIG. 7). When a rebel value is canceled for a member, the member, and its descendants that had inherited from the member, automatically inherit the decision value of its parent.

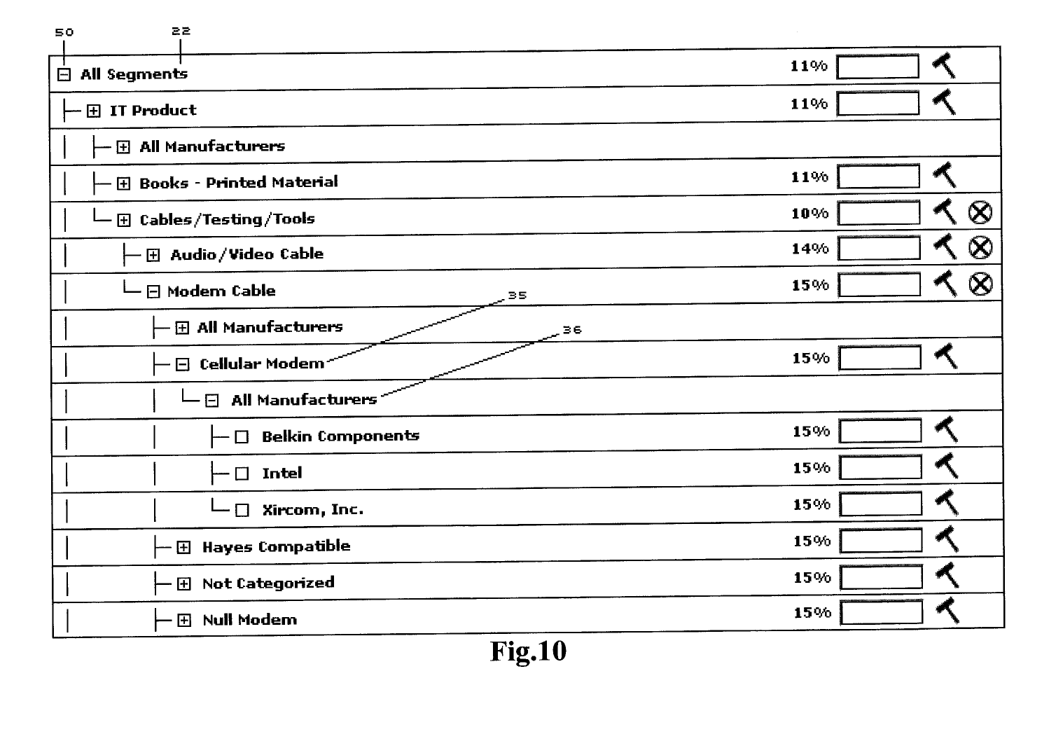

The adoption of a secondary attribute into the virtual single hierarchy is illustrated in FIGS. 8,9,and 10. In FIG. 8 the secondary attribute of the tree member 30 designated “All Manufactures” which has been adopted into the main category of products 32 identified as “IP Products” is shown. Since tree member 30 represents the same group of products as IT Products 32, the member 30 does not include an input box to enter a rebel value. All Manufacturers 30 have many members, making it necessary to group them alphabetically as shown in FIG. 8. At lower levels on the tree, this adopted secondary attribute contains fewer and fewer members. In FIG. 9, the tree member All Manufacturers 34 appears as a child member of the sub-category Modem Cables 33, which is a child member of the category Cable/Testing/Tools 24. The tree member All Manufacturers 34, may for example, include over thirty manufacturers, of which only the first eight are shown in FIG. 9. However, the tree member All Manufacturers 36, a child adopted member of the sub-category Cellular Modem 35, appearing in FIG. 10, has only three manufacturers. Thus, an adopted member brings less children when the member is adopted by a lower hierarchy member.

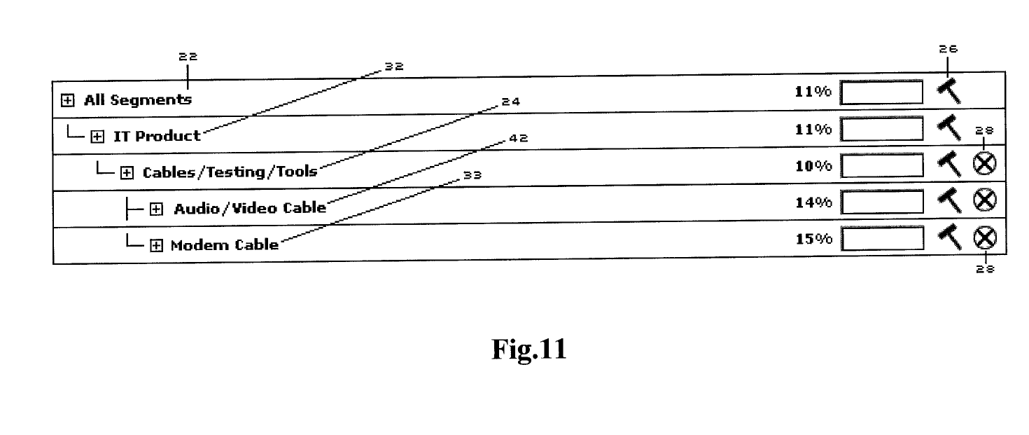

When the user is finished setting all the rebel decision values desired, he may click a shrink icon 50 to the left of the dominant ancestor 22, shown in FIG. 10, to reduce the display to the summary view shown in FIG. 11. In this view only the dominant ancestor 22, rebels 24, 42, 33 and the parent member on pathways to rebels 24, namely IT Product 32, are shown. To understand the summary display view, the user needs only to keep in mind the inheritance analogy. Any objects represented by members not shown must follow the decision value of the nearest rebel ancestor, or the dominant ancestor 22 if there is not a single rebel ancestor on the pathway to the dominant ancestor.

While a preferred embodiment of the invention has been shown and described, other and further embodiments of the invention may be devised without departing from the basic scope thereof, and the scope thereof is determined by the claims which follow.

1. A user interface method that displays a hierarchy of an attribute in a tree format for the purpose of applying values to objects represented by the members of the attributes in the hierarchy.

2. The method of claim 1 including the step of applying more than one type of value to objects represented by the members of the hierarchy.

3. The method of claim 1 wherein objects represented by more than one attribute hierarchy are incorporated into one virtual hierarchy by inserting other attribute hierarchies into the primary hierarchy to create one virtual hierarchy.

4. The method of claim 1 wherein values applied to objects represented by a higher hierarchy member in a tree are applied further on down the tree only to objects represented by members that are neither rebels, i.e. the user has not applied values to directly to members, nor direct descendants of rebels.

5. The method of claim 1 including the feature of canceling user's application of values to a member in the tree.

6. The method of claim 1 including providing a summary view of the tree hiding all other members except the highest hierarchical member identified as the dominant ancestor, rebel members to whom the user applied values directly and direct ancestors of the rebel members.

7. The method of claim 3 wherein inserted attributes carry only those members that belong to the hierarchical position that the attribute is inserted.
